(19) United States
(12) Patent Application Publication
(10) Pub. No.: US 2017/0294167 A1
(43) Pub. Date: Oct. 12, 2017

(54) CONTROLLING METHOD OF DECREASING POWER CONSUMPTION OF LIQUID CRYSTAL DISPLAY MODULE

(71) Applicant: Wuhan China Star Optoelectronics Technology Co., Ltd., Wuhan, Hubei (CN)

(72) Inventors: Qingcheng ZUO, Wuhan, Hubei (CN); Chao LIANG, Wuhan, Hubei (CN)

(21) Appl. No.: 15/302,171

(22) PCT Filed: Jun. 16, 2016
(86) PCT No.: PCT/CN2016/086006

§ 371 Date: Oct. 6, 2016

(30) Foreign Application Priority Data
Apr. 12, 2016 (CN) 201610225081.4

(51) Int. Cl. G09G 3/34; G09G 3/36

(52) U.S. Cl. CPC G09G 3/3406; G09G 3/36; G09G 2330/023; G09G 2320/0646; G09G 2320/0233

(57) ABSTRACT

A controlling method of decreasing a power consumption of a liquid crystal display module is described. The method provides steps of: increasing a voltage loading between two ends of liquid crystals and decreasing a back light driving current when a video image enable signal is within an image disable region, so as to keep the liquid crystal display module having a constant brightness. According to the controlling method, the voltage loading between two ends of the liquid crystal is increased when the video image enable signal is in the image disable region, so as to raise a light transmittance as the liquid crystal pixel works, raise a display brightness of the liquid crystal panel, decrease the back light driving current, reduce a back light brightness and ensure an entire display effect being constant when the video image enable signal is in the image disable region.

### FIELD OF THE INVENTION

The present invention relates to the field of crystal liquid display modules, and more particularly to a controlling method of decreasing a power consumption of a liquid crystal display module.

### BACKGROUND OF THE INVENTION

As people's reliance on mobile devices gradually increases, information access and processing are both being developed simultaneously towards raising a pixel density, which is based on a direction of figures. Wearable products or portable devices in all shapes, such as PAD, pen-shaped scanners, WAP phones, e-mail browsers, and other communication devices are increasingly being developed. The tasks in front of designers are how to further decrease the size, reduce the weight, and decrease the power consumption. As for liquid crystal display modules (LCM), the power consumption is the main factor restricting the device usage time.

As for the power consumption of LCM, two main portions of the consumption of liquid crystal panels and the consumption of the back light, can be classified. Comparing both, the consumption of back light has a larger ratio and usually up to about 70% or more. Therefore, to reduce the power consumption of LCM by reducing the consumption of the back light has become the study focus of researchers.

Please refer to FIG. 1. In the conventional screen display controlling system, when a video image enable signal DE is in an image enable region T1, the pixel voltages loading on pixels are respectively V1, V2, . . . Vn, a common voltage VCOM keeps unchanged, a back light module is in a current constant driving status, and a brightness of the back light keeps unchanged. When the video image enable signal DE is in an image disable region T2, a liquid crystal panel pixel writing voltage is in a maintaining status, the common voltage VCOM keeps unchanged. At this time, the pixel voltages loading on the pixels are still respectively V1, V2 . . . Vn, a penetration percent of each of the pixels is unchanged, and the back light module is in a current constant driving status, and the brightness of the back light keeps unchanged. In terms of small and medium-size LCMs, back light LEDs often run in a series connection manner, the back light driving voltage is relatively high, and a very small change will induce a huge waste in the entire power consumption of LCM. Therefore, when the video image enable signal DE is in an image disable region T2, the back light is always at a relatively high current status, and waste in the power consumption will be induced inevitably.

### SUMMARY OF THE INVENTION

A technical problem to be solved by the present invention is to provide a controlling method of decreasing a power consumption of a liquid crystal display module, which can decrease the entire power consumption of the liquid crystal display module under the condition that the brightness of liquid crystal display module is kept unchanged and the display effect is not affected.

To solve the above problem, the present invention provides a controlling method of decreasing a power consumption of a liquid crystal display module, comprising steps of: increasing a voltage loading between two ends of liquid crystals and decreasing a back light driving current when a video image enable signal is in an image disable region, wherein the step of increasing the voltage loading between the two ends of the liquid crystals comprises steps of: keeping an amplitude of a pixel writing voltage of the image disable region being consistent with an amplitude of a pixel writing voltage of an image enable region; decreasing a common voltage of the image disable region to increase the voltage loading between the two ends of the liquid crystals, when a polarity of the common voltage is identical to a polarity of the pixel writing voltage; and increasing the common voltage of the image disable region to increase the voltage loading between the two ends of the liquid crystals, when the polarity of the common voltage is opposite the polarity of the pixel writing voltage signal.

The present invention further provides a controlling method of decreasing a power consumption of a liquid crystal display module, comprising steps of: increasing a voltage loading between two ends of liquid crystals and decreasing a back light driving current when a video image enable signal is in an image disable region, so as to keep the liquid crystal display module having a constant brightness.

In a further embodiment, the step of increasing the voltage loading between the two ends of the liquid crystals comprises steps of: keeping an amplitude of a pixel writing voltage of the image disable region being consistent with an amplitude of a pixel writing voltage of an image enable region, and changing a common voltage of the image disable region to increase the voltage loading between the two ends of the liquid crystals in the image disable region.

In a further embodiment, the common voltage of the image disable region is decreased to increase the voltage loading between the two ends of the liquid crystals, when a polarity of the common voltage is identical to a polarity of the pixel writing voltage.

In a further embodiment, the common voltage of the image disable region is increased to increase the voltage loading between the two ends of the liquid crystals, when a polarity of the common voltage is opposite a polarity of the pixel writing voltage signal.

In a further embodiment, the pixel writing voltage is a pulse signal.

In a further embodiment, the method further comprises a step of: recovering the voltage loading between two ends of the liquid crystals to a voltage original value and recovering the back light driving current to a driving current original value, when the video image enable signal enters into an image enable region from the image disable region.

In a further embodiment, the method further comprises a step of: keeping the video image enable signal being in an image enable region, when the video image enable signal is at a high voltage level; and keeping the video image enable signal being in the image disable region, when the video image enable signal is at a low voltage level.

In a further embodiment, the method further comprises a step of: keeping the video image enable signal being in the image disable region, when the video image enable signal is at a high voltage level; and keeping the video image enable signal being in an image enable region, when the video image enable signal is at a low voltage level.

According to the present invention, the voltage loading between two ends of the liquid crystal is increased when the video image enable signal is in the image disable region, so as to raise a light transmittance as the liquid crystal pixel works, raise a display brightness of the liquid crystal panel, decrease the back light driving current, reduce a back light brightness and ensure an entire display effect unchanged when the video image enable signal is in the image disable region.

### DESCRIPTION OF THE DRAWINGS

FIG. 1 is a driving timing diagram of a conventional liquid crystal display module; and

FIG. 2 is a driving timing diagram of a controlling method of decreasing a power consumption of a liquid crystal display module of the present invention.

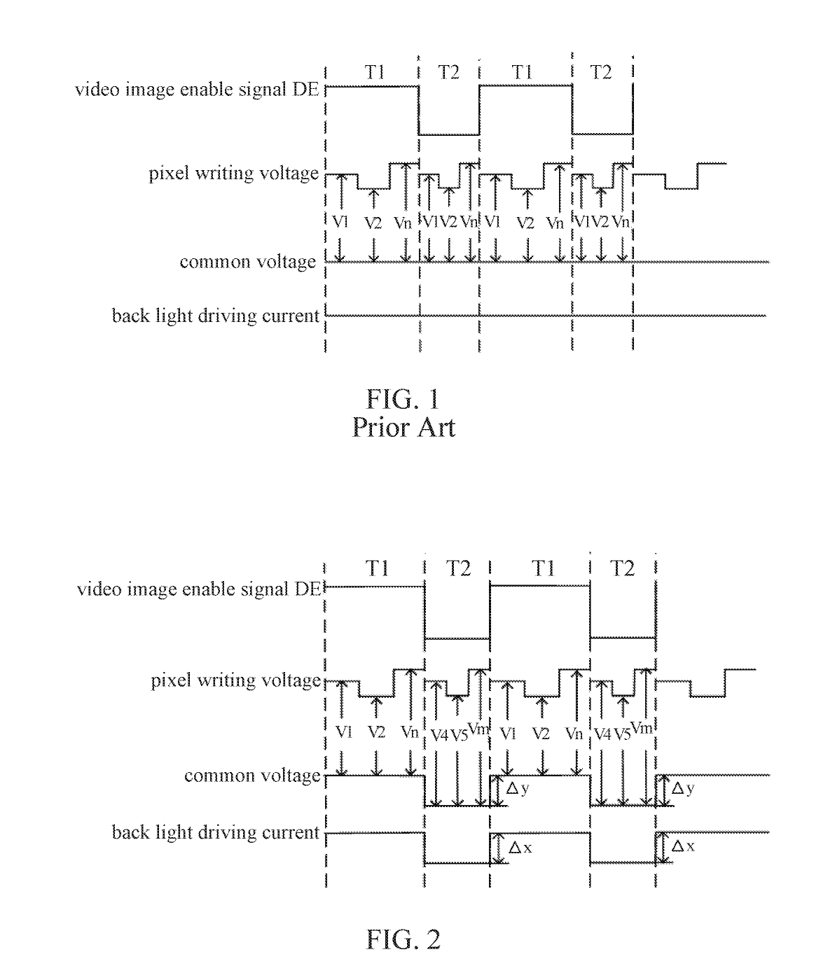

### DETAILED DESCRIPTION OF THE PREFERRED EMBODIMENTS

The specific embodiments of a controlling method of decreasing a power consumption of a liquid crystal display module provided by the present invention, in conjunction with the accompanying drawings, is described in detail below.

A controlling method of decreasing a power consumption of a liquid crystal display module of the present invention comprises steps of: increasing a voltage loading between two ends of liquid crystals and decreasing a back light driving current when a video image enable signal DE is in an image disable region T2, so as to keep the liquid crystal display module having a constant brightness.

Refer to FIG. 2. The video image enable signal DE includes image enable regions T1 and image disable regions T2, wherein the video image enable signal DE is kept being in the image enable region T1, when the video image enable signal DE is at a high voltage level; and the video image enable signal DE is kept being in the image disable region T2, when the video image enable signal DE is at a low voltage level. Certainly, it can be understood that in other embodiments the video image enable signal DE can be kept being in the image disable region T2, when the video image enable signal DE is at the high voltage level; and the video image enable signal DE is kept being in an image enable region T1, when the video image enable signal DE is at the low voltage level. The present invention is not limited thereto.

A waveform of a pixel writing voltage signal is a pulse signal, and a voltage between a pixel electrode and a common electrode is a voltage loading between two ends of liquid crystals, which means a pixel voltage. In the present specific embodiments of the present invention, the step of increasing the voltage loading between the two ends of the liquid crystals comprises steps of: keeping an amplitude of a pixel writing voltage signal of the image disable region T2 being consistent with an amplitude of a pixel writing voltage signal of an image enable region T1, and changing a magnitude of the common voltage Vcom to increase the voltage loading between the two ends of the liquid crystals in the image disable region T2, as described below in detail. The common voltage can be DC Vcom or AC Vcom.

When the video image enable signal DE is in an image enable region T1, the pixel writing voltage is inputted and the common voltage Vcom is kept unchanged. Then, the common voltage Vcom at this moment is defined as a common voltage original value. The voltages loading the two ends of the liquid crystals, which are pixel voltages respectively shown as V1, V2 . . . Vn, and the pixel voltage at this moment is defined as a pixel voltage original value. At this time, the back light is in a current constant driving status. As shown in FIG. 2 of the back light driving current, the back light driving current is kept unchanged, and the back light driving current at this moment is defined as a driving current original value. In the status, a light transmittance of each of the pixels is a constant value, a brightness of the back light is a constant value, and a display brightness of the liquid crystal display module is basically a constant value.

When the video image enable signal DE is in the image disable region T2, the common voltage Vcom is adjusted to have a change of Δy, and the voltages originally loading between the two ends of the liquid crystals, which are pixel voltages V1, V2, . . . Vn, are increased to respectively become V4, V5, . . . Vm, which means that there are relationships between the voltages as follows: V4=V1+Δy, V5=V2+Δy, . . . Vm=Vn+Δy. At this time, the light transmittance of each of all of the pixels increases since the voltage loading between the two ends of the liquid crystals increases.

For example, when a polarity of the common voltage is identical to a polarity of the pixel writing voltage signal, e.g., the common voltage original value is 1V, the voltage loading between the two ends of the liquid crystal, i.e., the pixel voltages respectively shown as V1, V2, . . . Vn. When the video image enable signal DE is in the image enable region T1, the common voltage Vcom is 1V and the voltages loading between the two ends of the liquid crystals are respectively shown as V1, V2, . . . Vn. When the video image enable signal DE is in the image disable region T2, the common voltage Vcom is decreased to become 0.8V, and the voltage loading between the two ends of the liquid crystals increases, which are respectively V4, V5, . . . Vm, wherein V4=V1+0.2V, V5=V2+0.2V, . . . Vm=Vn+0.2V. The voltage loading between the two ends of the liquid crystals increases, and the light transmittance of each of the pixels increases.

If a polarity of the common voltage is opposite to a polarity of the pixel writing voltage signal, e.g., the common voltage original value is −0.23V, the voltage loading between the two ends of the liquid crystal, i.e., the pixel voltages respectively shown as V1, V2, . . . Vn. When the video image enable signal DE is in the image enable region T1, the common voltage Vcom is −0.23V and the voltages loading between the two ends of the liquid crystals are respectively shown as V1, V2, . . . Vn. When the video image enable signal DE is in the image disable region T2, the common voltage Vcom is decreased to become −0.33V, and the voltage loading between the two ends of the liquid crystals increases, which are respectively V4, V5, . . . Vm, wherein V4=V1+0.1V, V5=V2+0.1V, . . . Vm=Vn+0.1V. The voltage loading between the two ends of the liquid crystals increases, and the light transmittance of each of the pixels increases.

In other specific embodiments of the present invention, inversion methods such as line inversion, column inversion, or dot inversion can be used to increase the voltage loading between the two ends of the liquid crystal. The inversion methods such as line inversion, column inversion, or dot inversion are well known methods, and are not repeated herein.

If the light transmittance of each of the pixels is simply increased, the brightness of the liquid crystal display module will be raised, and an unstable displaying of the liquid crystal display module is induced. Therefore, in the present invention, the light transmittance of each of the pixels increases while reducing the back light driving current, thereby reducing the brightness of the back light. Both of them coordinate with each other for keeping the entire brightness of the liquid crystal display module basically unchanged, as described below in detail.

When the video image enable signal DE is in the image enable region T1, the back light driving current is I. When the video image enable signal DE is in the image disable region T2, the back light driving current has a decrease Δx. When the video image enable signal DE is in the image disable region T2, the back light driving current is I−Δx. For example, when the video image enable signal DE is in the image enable region T1, the back light driving current is 20 mA; when the video image enable signal DE is in the image disable region T2, the back light driving current is smaller than 20 mA.

In the present invention, when the video image enable signal DE is in the image disable region T2, the back light driving current is reduced, thereby keeping the entire brightness of the liquid crystal display module basically unchanged. Usually, the power consumption decreased in the back light will be far greater than the power consumption increased due to the change of the common voltage Vcom. Therefore, in the condition without affecting the display effect, the entire power consumption of the liquid crystal display module is decreased.

When the video image enable signal enters into the image enable region T1 from the image disable region T2, the voltage loading between the two ends of the liquid crystals recovers to the pixel voltage original value, which means that the common voltage Vcom recovers to the common voltage original value, and the back light driving current recovers to the driving current original value, so as to keep the display ability of a liquid crystal pixel module unchanged.

When the video image enable signal DE is in the image disable region, all of the pixels are at a discharged maintaining status. A voltage difference loading between the two ends of the liquid crystals is increased by changing the common voltage at this moment, so as to increase the display brightness of the liquid crystal panel. Simultaneously, in the conditions of keeping the entire brightness of the liquid crystal display module unchanged, the back light current can be appropriately reduced, such that the effect of saving the entire power of the liquid crystal display module can be achieved.

As described above, the present invention has been described with a preferred embodiment thereof and it is understood that one of ordinary skill in the art without departing from the scope and the spirit of the invention, may make many changes and modifications and these should be also regarded as within the scope of the present invention.

1. A controlling method of decreasing a power consumption of a liquid crystal display module, comprising steps of:
increasing a voltage loading between two ends of liquid crystals and decreasing a back light driving current when a video image enable signal is in an image disable region,
wherein the step of increasing the voltage loading between the two ends of the liquid crystals comprises steps of:
keeping an amplitude of a pixel writing voltage of the image disable region being consistent with an amplitude of a pixel writing voltage of an image enable region;
decreasing a common voltage of the image disable region to increase the voltage loading between the two ends of the liquid crystals, when a polarity of the common voltage is identical to a polarity of the pixel writing voltage; and
increasing the common voltage of the image disable region to increase the voltage loading between the two ends of the liquid crystals, when the polarity of the common voltage is opposite the polarity of the pixel writing voltage.

2. The controlling method of decreasing the power consumption of the liquid crystal display module according to claim 1, wherein the pixel writing voltage is a pulse signal.

3. The controlling method of decreasing the power consumption of the liquid crystal display module according to claim 1, further comprising a step of: recovering the voltage loading between two ends of the liquid crystals to a voltage original value and recovering the back light driving current to a driving current original value, when the video image enable signal enters into the image enable region from the image disable region.

4. The controlling method of decreasing the power consumption of the liquid crystal display module according to claim 1, further comprising a step of: keeping the video image enable signal being in the image enable region, when the video image enable signal is at a high voltage level; and keeping the video image enable signal being in the image disable region, when the video image enable signal is at a low voltage level.

5. The controlling method of decreasing the power consumption of the liquid crystal display module according to claim 1, further comprising a step of: keeping the video image enable signal being in the image disable region, when the video image enable signal is at a high voltage level; and keeping the video image enable signal being in the image enable region, when the video image enable signal is at a low voltage level.

6. A controlling method of decreasing a power consumption of a liquid crystal display module, comprising steps of: increasing a voltage loading between two ends of liquid crystals and decreasing a back light driving current when a video image enable signal is in an image disable region, so as to keep the liquid crystal display module having a constant brightness.

7. The controlling method of decreasing the power consumption of the liquid crystal display module according to claim 6, wherein the step of increasing the voltage loading between the two ends of the liquid crystals comprises steps of: keeping an amplitude of a pixel writing voltage of the image disable region being consistent with an amplitude of a pixel writing voltage of an image enable region, and changing a common voltage of the image disable region to increase the voltage loading between the two ends of the liquid crystals in the image disable region.

8. The controlling method of decreasing the power consumption of the liquid crystal display module according to claim 7, wherein the common voltage of the image disable region is decreased to increase the voltage loading between the two ends of the liquid crystals, when a polarity of the common voltage is identical to a polarity of the pixel writing voltage.

9. The controlling method of decreasing the power consumption of the liquid crystal display module according to claim 7, wherein the common voltage of the image disable region is increased to increase the voltage loading between the two ends of the liquid crystals, when a polarity of the common voltage is opposite a polarity of the pixel writing voltage.

10. The controlling method of decreasing the power consumption of the liquid crystal display module according to claim 7, wherein the pixel writing voltage is a pulse signal.

11. The controlling method of decreasing the power consumption of the liquid crystal display module according to claim 6, further comprising a step of: recovering the voltage loading between two ends of the liquid crystals to a voltage original value and recovering the back light driving current to a driving current original value, when the video image enable signal enters into an image enable region from the image disable region.

12. The controlling method of decreasing the power consumption of the liquid crystal display module according to claim 6, further comprising a step of: keeping the video image enable signal being in an image enable region, when the video image enable signal is at a high voltage level; and keeping the video image enable signal being in the image disable region, when the video image enable signal is at a low voltage level.

13. The controlling method of decreasing the power consumption of the liquid crystal display module according to claim 6, further comprising a step of: keeping the video image enable signal being in the image disable region, when the video image enable signal is at a high voltage level; and keeping the video image enable signal being in an image enable region, when the video image enable signal is at a low voltage level.
